(19) United States
(12) Patent Application Publication
(10) Pub. No.: US 2013/0181061 A1
(43) Pub. Date: Jul. 18, 2013

(54) MITIGATION OF ORBITING SPACE DEBRIS BY MOMENTUM EXCHANGE WITH DRAG-INDUCING PARTICLES

(71) Applicants: Christian B. Carpenter, Monroe, WA (US); David Q. King, Woodinville, WA (US); Robert K. Masse, Redmond, WA (US); Charles Sota, Kirkland, WA (US); Robert H. Bagshaw, Sammamish, WA (US); Philip R. Horkin, Carnation, WA (US); David P. Patterson, Bellevue, WA (US)

(72) Inventors: Christian B. Carpenter, Monroe, WA (US); David Q. King, Woodinville, WA (US); Robert K. Masse, Redmond, WA (US); Charles Sota, Kirkland, WA (US); Robert H. Bagshaw, Sammamish, WA (US); Philip R. Horkin, Carnation, WA (US); David P. Patterson, Bellevue, WA (US)

(73) Assignee: AeroJet-General Corporation, Sacramento, CA (US)

(21) Appl. No.: 13/704,554

(22) PCT Filed: Feb. 17, 2011
(86) PCT No.: PCT/US11/25181

§ 371 Date: Mar. 8, 2013

Related U.S. Application Data
(60) Provisional application No. 61/305,257, filed on Feb. 17, 2010.

(51) Int. Cl. B64D 1/16

(52) U.S. Cl. CPC B64D 1/16
USPC 239/1

(57) ABSTRACT

A cloud of small to medium-sized space debris is mitigated by releasing drag-reducing particles into the cloud from a dispenser vehicle, causing the particles to collide or otherwise interact with, and thereby exchange momentum with, the debris particles, reducing the orbiting velocity of the debris to a degree sufficient to cause the debris to de-orbit, or to accelerate the de-orbiting of the debris, to Earth. Certain embodiments also include a shepherd vehicle containing systems for identifying and tracking the debris cloud and for coalescing the debris cloud to increase the particles density in the cloud.

### BACKGROUND OF THE INVENTION

1. Field of the Invention

This invention resides in the field of space debris, i.e., small undesired objects orbiting the Earth that present a hazard to satellites, space stations, and astronauts, and in efforts to remove or mitigate such debris.

2. Description of the Prior Art

Objects orbiting the Earth as litter in low Earth orbit (i.e., at a distance of from about 160 km to about 2,000 km, approximately equal to about 100 miles to about 1,240 miles, from the Earth's surface) are estimated to number in the hundreds of thousands, and perhaps more. This space debris is largely the result of accidental events such as the collision in 1991 between the Russian satellite Cosmos 1934 and a piece of debris from its sister satellite Cosmos 926, the collision in 1996 between the French satellite Cerise and a fragment from the third stage of an Ariane 1 launch vehicle, the collision in 2005 between the upper portion of a Thor Burner 2A final stage and a fragment of the third stage of a Chinese CZ-4 launch vehicle, and the collision in 2009 between the Iridium 33 satellite and the Cosmos 2251. These and other events have produced orbiting debris of a wide range of sizes, including what are estimated to be from about 300,000 to about 1,000,000 pieces that are between 0.1 cm and 10 cm in size (i.e., radar cross sections). While objects larger than 10 cm are also present, those within the 0.1 cm to 10 cm range present a special hazard due to their large number and can be highly destructive despite their small size. A 1-cm object, for example, is approximately the size of a .38-caliber bullet and can strike a satellite with a relative speed of 5-10 km/sec. This can leave a trail of destruction through the satellite or obliterate the satellite entirely and create thousands of pieces of new debris. Another problem with particles in the 0.1 cm to 10 cm size range is that they exist primarily as debris clouds which are particularly difficult to locate and track, unlike large monolithic objects that can be, removed by grapple and de-orbit operations. For these and other reasons, the tracking and cleanup of orbiting debris have become a necessity to the mission success of the world's space assets, including communication and navigation satellites, environmental monitoring satellites, the Hubble Space Telescope, and the International Space Station.

### SUMMARY OF THE INVENTION

It has now been discovered that debris particles in Earth orbit, and particularly those that are approximately 10 cm or less in size and orbiting in debris clouds, can be mitigated by placing drag-inducing particles in an orbit that intersects with the orbit of the debris particles and that causes particles from the two groups of particles to exchange momentum through collisions or other interactions, or both, that will produce an alteration in the orbit of the debris particles. The alteration can be one that promotes, i.e., either causes or accelerates, the de-orbiting of the debris particles or one that places the debris particles in a different, and preferably less hazardous, orbit. The term “de-orbit” is used herein to denote the falling of an object back in the direction of the Earth's surface, as a result of which the particles will either fall to an altitude at which they will be destroyed by drag from the Earth's atmosphere, or fall to the Earth's surface itself for collection, retrieval, destruction, or disposal. The promotion of de-orbiting will thus reduce the time required for the debris particles to de-orbit or at least to reduce in altitude sufficiently to promote their destruction, and such return or reduction in altitude can occur either immediately or by reducing their orbit to cause the orbit to decay over a shorter period of time than it would in the absence of momentum exchange with the drag-inducing particles. This change in orbit can occur either by altitude reduction in at least a portion of the debris particles' orbit to such an extent that the time for de-orbit of the debris particles to Earth by natural orbital decay is reduced, or by inducing the particles into a direct de-orbit trajectory. The alternative of placing the debris particles in a different, and preferably less hazardous, orbit is similarly achieved by altering the velocity of the debris particles through momentum exchange with the drag-inducing particles. The different orbit can for example be one that is further from the Earth than low Earth orbits, or one that does not coincide with the known orbits of satellites or other orbiting objects that are functional to operations at the Earth's surface.

The “drag-inducing particles” are so-called in view of their drag-inducing effect on the debris particles, this effect being the result of the exchange of momentum between the two sets of particles as they collide or otherwise interact. In optimal applications of this discovery, the drag-inducing particles themselves undergo a sufficient reduction in orbital velocity, in addition to the reduction experienced by the debris particles, that at least a substantial portion of both sets of particles de-orbit to Earth either directly or that the particles fall more rapidly into an orbit sufficiently low that the time for de-orbit to Earth by natural orbital decay is substantially reduced. The drag-inducing particles can be placed in orbit by a space vehicle, referred to herein as a “dispenser vehicle,” that carries the particles as a payload or that carries a material that when released from the vehicle forms drag-inducing particles. The payload can thus either be in the form of the drag-inducing particles themselves or of a non-particulate mass that assumes particulate form upon release. The payload can be a propellant. The dispenser vehicle can itself be launched into orbit and programmed or controlled to release (dispense) its particles at a point in the orbit where the released particles will interact with the debris particles to achieve the greatest mutual momentum transfer for both particles.

Certain embodiments or implementations of the discovery also include a debris coalescence or re-direction function to either densify the debris cloud and thereby increase the concentration of the debris particles per unit volume in the cloud, or re-direct the paths of travel of at least a portion of the debris particles, prior to the impact of the drag-inducing particles. The increase in particle concentration, or cloud density, will increase the probability of interaction of the debris particles with the drag-inducing particles and thereby improve the efficiency of the debris mitigation system. Re-direction of the paths of travel of the debris particles can also increase the probability of interaction, either by concentrating the debris particles or placing them more directly in the path of the drag-inducing particles. The coalescence function, re-direction function, or both can be performed by a separate space vehicle, referred to herein as a “shepherd vehicle.”

The present invention thus resides both in processes for space debris mitigation and in systems for space degree mitigation, the systems containing the dispensing vehicle and the payload of drag-inducing particles, and for those embodiments that include coalescence and tracking functions, a shepherd vehicle that incorporates these functions.

These and other objects, features, and advantages of the present invention and its various embodiments are described in more detail below.

### DETAILED DESCRIPTION OF EMBODIMENTS OF THE INVENTION

A wide range of types of particles are suitable for use as the drag-inducing particles, including solid particles, liquid particles, and gaseous particles. The term “gaseous particles,” as used herein, refers to single molecules of gas. The liquid particles are globules of liquids, including pure liquids, solutions, or suspensions or other multi-phase mixtures. The solid particles, which can offer more opportunities for control of the particle characteristics, are either pure materials, agglomerated materials, or solid solutions. Different particles and particle types can be combined to tailor the characteristics of the deployed cloud of drag-inducing particles. Drag-inducing particles can also undergo a change in state or chemical composition during or after deployment. As one example, the drag-inducing particle material can be stored as a liquid and sprayed as small droplets which solidify by flash freezing once outside the dispenser vehicle. In another example, the drag-inducing particle material is a solid, gas, liquid, or hybrid propellant that is stored onboard the dispenser vehicle and expelled by a thruster through a nozzle, which can be directed to both provide thrust to the dispenser vehicle and populate a desired orbit with drag-inducing particles. In cases where deployment of the drag-inducing particles provides thrust to the dispenser vehicle, drag-inducing particle deployment can be used to de-orbit the deployment vehicle or move it to an alternate orbit. Drag-inducing particles may also be of compositions that cause them to sublimate gradually into gas upon deployment. Drag-inducing particles can either be electrically neutral or bear an electrical charge. The electrical charge can be incorporated in the particles prior to the loading of the particles in the dispenser vehicle or prior to their release into orbit or into the debris cloud. Alternatively, particles that become charged in response to the Earth's magnetic field or an applied magnetic field can be used. As a further alternative, particles can be charged, or their charge can be increased, by artificially induced means such as exposing the particles to a charged particle beam subsequent to, or simultaneous with, their release. Charged particles are useful in certain applications for directing the path of travel of the particles to enhance the collisions. Charged drag-inducing particles have the added advantage of being able to exchange momentum with, i.e. exert a drag force on, charged debris particles without actually colliding with them. This increases the probability, and resulting net rate, of momentum exchange.

The composition, physical state, shapes, and dimensions of the drag-inducing particles can vary widely, although the convenience, effectiveness, and efficiency of the particles will vary with certain factors. Particle size and the densities of individual particles are two of these factors. Optimal particles will be sufficiently small to pose at most a minimal threat to space assets other than the target debris particles, yet large enough to inhibit particle spreading upon release. These considerations will also be affected by the individual particle mass. The ability to control the timing of the release of the particles and the direction of their travel upon release are further considerations in selecting and designing the particles. Particles that can be stored in a dense or highly confined manner in a vehicle payload will also have advantages in many cases, as will particles that have little or no tendency to conglomerate upon release. A low rate of particle spread can in many cases be achieved by using particles of selected size, mass, or charge, or combinations of these properties.

Debris mitigation will be greatest when the collision results in a high degree of momentum exchange between the drag-inducing particles and the debris particles. Factors affecting momentum exchange include the mass, velocity, and charge of the drag-inducing particles, and the angle of approach of the drag-inducing particles relative to the trajectory of the debris particles. In terms of mass and velocity, a relatively low value of one can be offset by a relatively high value of the other. The angle of approach is addressed below.

As noted above, the drag-inducing particles are preferably placed in orbit so that their path of travel intersects with the orbit of the debris cloud. It will often be most effective to place the drag-inducing particles in an orbit that coincides with the orbit of the debris cloud, and preferably with the two sets of particles orbiting in opposite directions to achieve direct collisions and to maximize the loss of orbital angular momentum of the debris particles.

Mitigation of a debris cloud can also be enhanced by identification (locating the cloud and determining its size) and tracking of the cloud. Identification and tracking can be achieved by conventional means, either directly from the Earth's surface, through equipment on the dispenser vehicle, or through equipment on the shepherd vehicle mentioned above (and described further below). Optical tracking can be performed by visual observation enhanced by telescope or from infrared images. Examples of other suitable tracking technologies include radar, LIDAR (light detection and ranging, or laser radar), floating potential probes, and electrodynamic tethers. In general, any means of debris tracking can be employed in the practice of this invention.

The timing of the release of the drag-inducing particles or the locations of the two sets of particles in their respective orbits can be selected to cause the collision to occur at a selected location. Considerations at the Earth's surface will influence the selection of the location in many cases. In many cases as well, debris clouds travel in orbits that display a volumetric resonance resulting in one or more orbital nodes where the density of the debris cloud is maximized. For these clouds, the drag-inducing particles will have their optimal effect in proximity to these nodes. The term “proximity” in relation to an orbital node is used herein to mean either coincident with a node or close enough to the node that an exchange of momentum will occur at the node. Identification of the node location(s) and tracking of the orbiting debris to determine the point in time when the debris are at this location(s) can be performed by the identification and tracking means described above.

Coalescence of the debris (compaction of the cloud) can be accomplished by the shepherd vehicle in a variety of ways. Optimally, the debris cloud is coalesced toward its center of mass, and the preferred orbital location for this is the aforementioned resonance node. The debris orbit resides in a low-density plasma within the Earth's magnetic field, and the debris will become charged due to natural effects. One means of coalescence is to impart a magnetic field on the charged debris particles to deflect the particles in a selected direction. A magnetic field can be formed by the shepherd vehicle to vary the strength and direction of the magnetic field lines within the debris cloud. The particles in a portion of the debris cloud can be steered in a direction that will cause coalescence of the cloud as a whole by projecting a magnetic field into that portion of the cloud to deflect the particles in that direction.

Coalescence can also be achieved by imparting a propulsive impulse to the debris particles or to a portion of, or one side of, the debris cloud. One means of accomplishing this is to expel a plume of particles into the cloud to direct the particles in a particular direction, such as by using the propulsion system of the shepherd vehicle. Another means of accomplishing this for a particular debris particle is to ablate a small amount of material from one side of the particle. Ablation can be achieved, for example, by a pulsed laser, radiofrequency, or microwave beam. Tracking of individual debris particles can enhance the effectiveness and accuracy of the ablation. When a propulsive impulse is used, a change in velocity of about 10 m/s/particle (meters per second per particle) or less will most often be sufficient.

A still further means of coalescence is to deflect the debris in a particular direction by use of an applied electric field. This can be accomplished by a charged electrode or the use of a charged particle beam directed to portions of the cloud such that the force created by the beam will either repel or attract the particles, depending on the polarity of the beam and the charges on the particles. Electromagnetic deflection can also be used in conjunction with other means to increase the efficiency of the system.

A fourth means of coalescence is the formation of a large body wake into which the debris particles will be drawn and concentrated. The travel of a large body will produce a wake in which the plasma properties will differ from those of the surrounding regions, for example by having a lower plasma density. Debris in the wake will therefore encounter lower drag and will become concentrated inside the wake as a result. A wake can be created, for example, by forming a large electromagnetic field or plasma bubble around the shepherd vehicle or by inflating or mechanically deploying a large gossamer structure such as a solar sail.

In one contemplated means of operation, the shepherd vehicle is launched into orbit on a mission preceding the launching of the dispenser vehicle, or if both are launched at the same time, the shepherd vehicle can be programmed to perform its functions prior to dispensing of the particles from the dispenser vehicle. Once in orbit, the shepherd vehicle can scan the debris cloud to identify the type and size of the particles in the cloud and to track their trajectories as a supplement to ground-based tracking efforts. The shepherd vehicle can then perform a coalescing operation by any of the various means described above. Once the debris cloud has been coalesced and densified, the dispenser vehicle mission is initiated and the drag-inducing particles are released into orbit. The shepherd vehicle then continues to track the debris cloud and the progress of its mitigation. Once the desired degree of mitigation has been achieved, the shepherd vehicle can then be redirected to another cloud or orbit, or de-orbited. Re-direction of the shepherd vehicle can be achieved by a small orbit-transfer propulsion system that can be incorporated into the vehicle.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

1. A process for mitigating the presence of debris particles in an Earth orbit, said process comprising:
(a) launching into space a vehicle carrying a payload that upon ejection from said vehicle forms drag-inducing particles, and (b) ejecting said payload from said vehicle to place said drag-inducing particles into an Earth orbit that intersects with said Earth orbit of said debris particles, such that said drag-inducing particles exchange momentum with said debris particles and thereby alter said Earth orbit of said debris particles.

2. The process of claim 1 wherein step (b) comprises altering said Earth orbit of said debris particles in a manner that accelerates de-orbiting of said debris particles.

3. The process of claim 1 wherein step (b) comprises causing a reduction of orbital velocity of said drag-inducing particles and thereby accelerating de-orbiting of said debris particles.

4. The process of claim 1 wherein said Earth orbits of both said debris particles and said drag-inducing particles are low Earth orbits.

5. The process of claim 1 wherein said debris particles are from about 0.1 cm to about 10 cm in size.

6. The process of claim 1 further comprising tracking said Earth orbit of said debris particles to locate an orbital node of said debris particles, and wherein step (b) comprises causing said drag-inducing particles to exchange momentum with said debris particles in proximity to said orbital node.

7. The process of claim 1 wherein said Earth orbit of said debris particles and said Earth orbit of said drag-inducing particles are substantially coincident but opposite in directions.

8. The process of claim 1 wherein said drag-inducing particles are solid particles.

9. The process of claim 1 wherein said drag-inducing particles are liquid particles.

10. The process of claim 1 wherein said drag-inducing particles are gas particles.

11. The process of claim 1 wherein said drag-inducing particles are charged particles.

12. The process of claim 1 wherein said debris particles comprise a debris cloud, said vehicle of step (a) is defined as a dispenser vehicle, and said process further comprises launching a vehicle defined as a shepherd vehicle, said shepherd vehicle comprising means for coalescing said debris cloud prior to step (b) to produce an increase in concentration of said debris particles in said cloud.

13. The process of claim 2 wherein said debris particles comprise a debris cloud, said vehicle of step (a) is defined as a dispenser vehicle, and said process further comprises launching a vehicle defined as a shepherd vehicle, said shepherd vehicle comprising means for coalescing said debris cloud prior to step (b) to produce an increase in concentration of said debris particles in said cloud.

14. The process of claim 3 wherein said debris particles comprise a debris cloud, said vehicle of step (a) is defined as a dispenser vehicle, and said process further comprises launching a vehicle defined as a shepherd vehicle, said shepherd vehicle comprising means for coalescing said debris cloud prior to step (b) to produce an increase in concentration of said debris particles in said cloud.

15. The process of claim 12 wherein said shepherd vehicle further comprises means for identifying said debris cloud and tracking said debris cloud.

16. The process of claim 12 wherein said means for coalescing said debris cloud comprises means for projecting a magnetic field, and said process further comprises projecting said magnetic field into said debris cloud to cause said coalescence.

17. The process of claim 12 wherein said means for coalescing said debris cloud comprises a particle-ablating laser, radiofrequency, or microwave beam, and said process further comprises directing pulsed laser energy from said particle-ablating laser, radiofrequency energy, or a microwave beam at said debris cloud to produce a propulsive impulse sufficient to cause said coalescence.

18. The process of claim 12 wherein said means for coalescing said debris cloud comprises means for projecting a charged particle beam, and said process further comprises projecting said charged particle beam into said debris cloud to impart an electric charge to a portion of said debris cloud sufficient to cause said coalescence.

19. The process of claim 12 wherein said means for coalescing said debris cloud comprises means for forming a wake behind said dispenser vehicle, and said process further comprises forming said wake and dispensing said drag-inducing particles into said wake.

20. The process of claim 12 wherein said debris cloud has a center of mass, and said means for coalescing said debris cloud comprises means for directing particles of said debris cloud toward said center of mass.

21. The process of claim 12 wherein said debris cloud has a center of mass, and said means for coalescing said debris cloud comprises means for directing particles of said debris cloud toward said center of mass while said center of mass is in proximity to said orbital node.

22. The process of claim 12 wherein said drag-inducing particles are solid particles.

23. The process of claim 12 wherein said drag-inducing particles are liquid particles.

24. The process of claim 12 wherein said drag-inducing particles are gas particles.

25. The process of claim 12 wherein said drag-inducing particles are charged particles.
